(19) United States
(12) Patent Application Publication
(10) Pub. No.: US 2005/0052587 A1
(43) Pub. Date: Mar. 10, 2005

(54) Display device

(75) Inventors: Takaaki Kitada, Ooamishirasato (JP); Toshiyuki Amimoto, Mobara (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 10/934,692

(22) Filed: Sep. 7, 2004

(30) Foreign Application Priority Data
Sep. 10, 2003 (JP) 2003-318308

(51) Int. Cl. G02F 1/1335

(52) U.S. Cl. 349/58

(57) ABSTRACT

The present invention can enhance the impact resistance in a display device provided with a lower frame having mounting portions. In a display device including a display panel and a lower frame which is arranged on a side opposite to a display screen of the display panel, the lower frame includes a body portion which is positioned on a back surface side of the display screen of the display panel, a mounting portion which projects toward the outside of the display panel, and a plurality of connecting portions which connect the body portion and the mounting portion. The plurality of connecting portions is folded toward the mounting portions from the body portion.

### BACKGROUND OF THE INVENTION

The present invention relates to a display device, and more particularly to a technique which is effectively applicable to a display device which includes a lower frame having mounting portions.

A liquid crystal display module has been popularly used as a display device of a personal computer, a monitor, a television receiver set or the like.

This liquid crystal display module is constituted of a liquid crystal display panel which arranges a drain driver and a gate driver on a periphery thereof and a backlight which illuminates the liquid crystal display panel.

The backlight is roughly classified into a side-light type backlight and a direct backlight (see patent document 1).

With respect to the liquid crystal display module used as a display device of a notebook type personal computer, a side-light type backlight has been mainly adopted.

Recently, the liquid crystal display module has become large-sized and hence has become to possess a large-sized screen and, at the same time, has been used as a display device for monitoring. A direct backlight which can obtain a high brightness is suitable for the large-sized liquid crystal display module having the large screen.

Here, as prior art document relevant to the present application, JP-A-5-257141 is exemplified.

The above-mentioned liquid crystal display module is mounted in a casing and is used as a display device of a personal computer, a monitor or the like.

Accordingly, in the liquid crystal display module having the direct backlight, to four corners of a lower frame which is formed on a back surface side (side opposite to a display screen of a liquid crystal display panel) of the direct backlight, mounting portions for mounting the liquid crystal display module on the casing are provided.

### SUMMARY OF THE INVENTION

However, in the above-mentioned conventional liquid crystal display module having the direct backlight, it is difficult to increase a width of connecting portions which connect the mounting portions and a body portion of the lower frame and hence, there exists a possibility that the connecting portions are deformed when a given impact or an impact which exceeds the given impact is applied to the connecting portions.

Further, in the conventional liquid crystal display module having the direct backlight, no special structure is adopted for positioning an upper frame which is provided to a surface side of the liquid crystal display panel (display screen side of the liquid crystal display panel) and the lower frame and hence, there exists a possibility that the positional displacement occurs between the upper frame and the lower frame when the liquid crystal display module is assembled.

The present invention has been made to overcome the above-mentioned drawbacks of the related art and it is an object of the present invention to provide a technique which can enhance the impact resistance in a display device provided with a lower frame having mounting portions.

Further, it is another object of the present invention to provide a technique which, in a display device provided with an upper frame and a lower frame, can easily position the upper frame and the lower frame.

The above-mentioned and other objects and novel features of the present invention will become apparent in view of the description of this specification and attached drawings.

To briefly explain the representative inventions among the inventions disclosed in this specification, they are as follows.

To achieve the above-mentioned object, the present invention is directed to a display device which includes a display panel and a lower frame which is arranged on a side opposite to a display screen of the display panel, wherein the lower frame includes a body portion which is positioned on a back surface side of the display screen of the display panel, a mounting portion which projects toward the outside of the display panel, and connecting portions which connect the body portion and the mounting portion, in which the improvement is characterized in that the connecting portions are provided in plural number to enhance the strength of the connecting portions.

Further, the present invention is directed to a display device which includes a display panel and a lower frame which is arranged on a side opposite to a display screen of the display panel, wherein the lower frame includes a body portion which is positioned on a back surface side of the display screen of the display panel, a mounting portion which projects toward a side opposite to the display screen of the display panel from the body portion, and connecting portions which connect the body portion and the mounting portion, in which the improvement is characterized in that the connecting portion are provided in plural number to enhance the strength of the connecting portions.

Further, the present invention is directed to a display device which includes a display panel, an upper frame which is arranged at a display screen side of the display panel, and a lower frame which is arranged on a side opposite to a display screen of the display panel, wherein the lower frame includes a mounting portion which projects toward the outside of the display panel, and the upper frame includes a projecting portion which projects toward the outside of the display panel and is fixed to the mounting portion of the lower frame, in which the improvement is characterized in that the mounting portion of the lower frame has a second mounting hole and a raised portion which is formed around the second mounting hole, and the raised portion is inserted into the first mounting hole which is formed in the projecting portion of the upper frame thus positioning the mounting portion of the lower frame and the projecting portion of the upper frame.

Further, the present invention is, in the above-mentioned display device, characterized in that the projecting portion of the upper frame has a first mounting hole and a raised portion which is formed around the first mounting hole, and the raised portion is inserted into the second mounting hole which is formed in the mounting portion of the lower frame thus positioning the mounting portion of the lower frame and the projecting portion of the upper frame.

Further, the present invention is, in the above-mentioned display device, characterized in that a raised portion for positioning the mounting portion of the lower frame and the projecting portion of the upper frame is formed on the projecting portion of the upper frame.

Further, the present invention is, in the above-mentioned display device, characterized in that a raised portion for positioning the mounting portion of the lower frame and the projecting portion of the upper frame is formed on the mounting portion of the lower frame.

To briefly explain advantageous effects obtained by the representative inventions among the inventions disclosed in this specification, they are as follows.

(1) It is possible to enhance the impact resistance according to the display device of the present invention.

(2) It is possible to easily perform the positioning of the upper frame and the lower frame according to the display device of the present invention.

### BRIEF DESCRIPTION OF THE DRAWINGS

FIG. 1 is an exploded perspective view showing the schematic constitution of a liquid crystal display module according to the present invention;

FIG. 2-a is a view showing aback surface side of the liquid crystal display module (side opposite to a display screen of the liquid crystal display panel) shown in FIG. 1;

FIG. 2-b is a view showing a portion A in FIG. 2-a in an enlarged manner;

FIG. 3-a is a view showing a back surface side of a liquid crystal display module (side opposite to a display screen of the liquid crystal display panel) of an embodiment 2 of the present invention;

FIG. 3-b is a view showing a portion B in FIG. 3-a in an enlarged manner;

FIG. 4-a is a view showing a front surface side of a liquid crystal display module (a display screen side of the liquid crystal display panel) of an embodiment 3 of the present invention;

FIG. 4-b is a cross-sectional view taken along a line A-A in FIG. 4-a;

FIG. 4-c is a view of a portion B in FIG. 4-a as viewed from a back surface side (side opposite to the display screen of the liquid crystal display panel);

FIG. 5 is a cross-sectional view showing a modification 1 of the embodiment 3 of the present invention;

FIG. 6-a is a schematic view of a projecting portion of an upper frame as viewed from the front surface side (display screen side of the liquid crystal display panel) in a modification 2 of the embodiment 3 of the present invention;

FIG. 6-b is a cross-sectional view taken along a line A-A in FIG. 6-a;

FIG. 7-a is a schematic view of a projecting portion of an upper frame as viewed from the front surface side (display screen side of the liquid crystal display panel) in a modification 3 of the embodiment 3 of the present invention;

FIG. 7-b is a cross-sectional view taken along a line A-A in FIG. 7-a;

FIG. 8 is a cross-sectional view for explaining a modification 4 of the embodiment 3 of the present invention;

FIG. 9-a is a view showing a back surface side of a conventional liquid crystal display module (side opposite to a display screen of the liquid crystal display panel); and

FIG. 9-b is a view showing a portion A in FIG. 9-a in an enlarged manner.

### DESCRIPTION OF THE PREFERRED EMBODIEMENTS

Preferred embodiments of the present invention are explained in detail hereinafter in conjunction with attached drawings.

Here, in all drawings which explain the embodiments, parts having identical functions are indicated by same symbols and their repeated explanation is omitted.

[Embodiment 1]

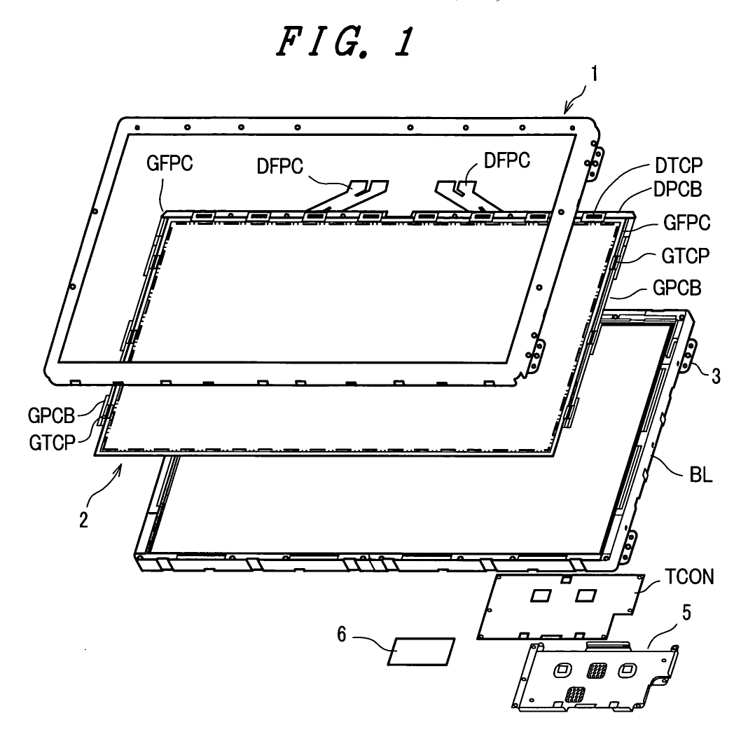

FIG. 1 is an exploded perspective view showing the schematic constitution of a liquid crystal display module according to the present invention.

The liquid crystal display module is constituted of a frame-like upper frame (also referred to as a shield casing, an upper casing or a metal upper frame) 1 made of a metal sheet, a liquid crystal display panel 2 and a backlight (BL).

The liquid crystal display panel 2 includes a pair of substrates (made of a material having light transmitting property and electric insulation property such as glass, for example) which are overlapped to each other with a liquid crystal layer sandwiched therebetween, a drain printed circuit board (DPCB) which is positioned in the periphery of the pair of substrates, and two gate printed circuit boards (GPCB).

On each printed circuit board, a tape carrier package (DTCP, GTCP) on which a group formed of a plurality of liquid crystal driving semiconductor integrated circuit elements (drive ICs) is mounted using tape automated bonding (TAB) is mounted.

The liquid crystal display module of this embodiment further includes a flexible printed circuit board (DFPC) which supplies signals or electricity to these drive ICs and a connection flexible printed circuit board (GFPC) which connects a drain printed circuit board (DFCB) and a gate printed circuit board (GPCB).

Here, on one substrate, pixel electrodes, thin film transistors and the like are formed and hence, the substrate is generally also referred to a TFT substrate. Further, on another substrate, counter electrodes, color filters and the like are formed and hence, the substrate is generally also referred to as a filter substrate.

The pair of substrates is overlapped to each other with a given gap therebetween and both substrates are laminated to each other using a sealing material which is formed in a frame shape in the vicinity of a peripheral portion between both substrates. Liquid crystal is filled into the inside of the sealing material between both substrates through a liquid crystal filling port formed in a portion of the sealing material and, thereafter, the liquid crystal is sealed in the inside of the sealing material. Further, polarizers are laminated to the outside of both substrates thus constituting a liquid crystal display panel 2.

Further, the flexible printed circuit boards (DFPC) are connected to a printed circuit board (including integrated circuit elements such as a timing converter) (Tcon) which is mounted on a lower surface of the backlight (BL).

Here, in FIG. 1, numeral 5 indicates a cover of the printed circuit board (Tcon) and numeral 6 indicates a label.

As shown in FIG. 1, on an upper side of the assembled liquid crystal display panel 2, the upper frame 1 formed of a metal plate is arranged such that a display window of the upper frame 1 has a main surface thereof corresponding to an effective display region of the liquid crystal display panel 2 exposed. Accordingly, the upper frame 1 has the frame-like planar structure.

Further, an upper side of the upper frame 1 is covered with a housing (not shown in the drawing) provided with a display window of a personal computer or the like, for example.

To explain this embodiment in conjunction with an example in which the embodiment is applied to a personal computer, a user looks at the liquid crystal display panel 2 shown in FIG. 1 from an upper surface side and recognizes images displayed on an effective display region.

The backlight (BL) shown in FIG. 1 is a direct backlight. Although omitted from the drawing, generally, in the direct backlight (BL), between a mold made of synthetic resin and a lower frame 3 made of metal, a plurality of cold cathode fluorescent lamps, a diffusion plate, a lower diffusion sheet, a prism sheet and an upper diffusion sheet are arranged in the above-mentioned order.

Further, by clamping and fixing the assembled liquid crystal display panel 2 with the upper frame 1 and the backlight (BL), the liquid crystal display module is completed.

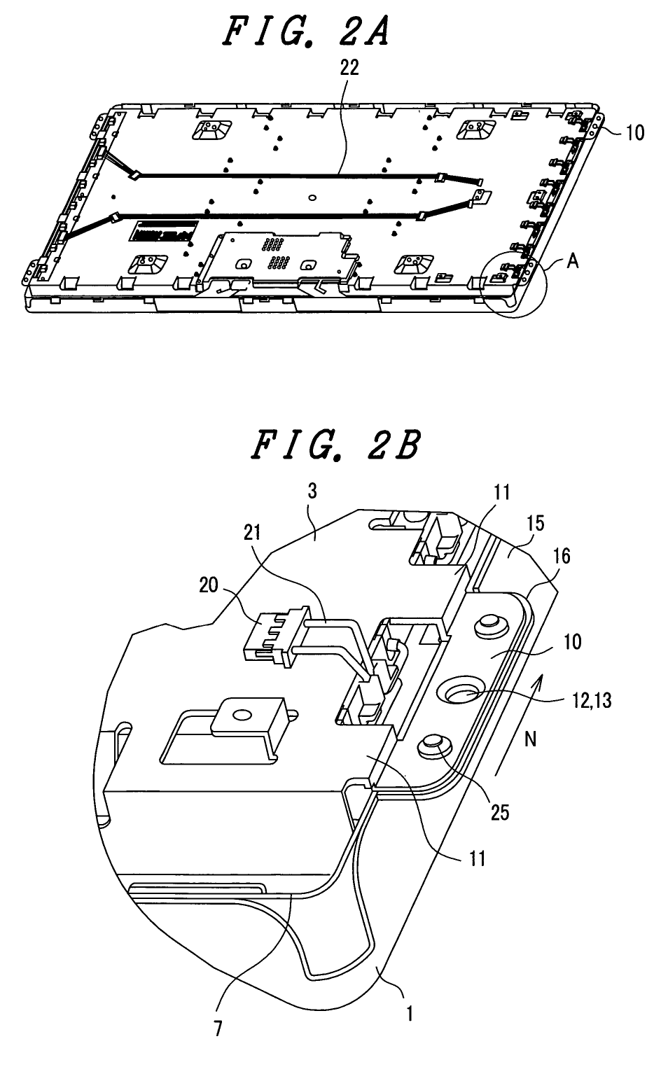

FIG. 2-a is a view showing aback surface side of the liquid crystal display module (side opposite to a display screen of the liquid crystal display panel) shown in FIG. 1, and FIG. 2-b is a view showing a portion A in FIG. 2-a in an enlarged manner.

As shown in FIG. 2, mounting portions 10 are formed at four corners of the lower frame 3.

The mounting portions 10 are formed such that the mounting portions 10 project toward the outside of the display panel 2 and are connected with a body portion (the portion positioned at a back surface side opposite to a display screen of the display panel 2) of the lower frame 3 using connecting portions 11.

In this manner, the mounting portions 10 of the lower frame 3 are formed on the display panel side rather than the body portion of the lower frame 3 and hence, the connecting portions 11 are folded toward the mounting portions 10 of the lower frame 3 from the body portion of the lower frame 3.

Further, as shown in FIG. 2, the upper frame 1 includes projecting portions (or flanges) 16 which are formed on side walls 15, and the mounting portions 10 of the lower frame 3 and the projecting portions 16 of the upper frame 1 are fixed to each other using screws 25. Due to such a constitution, the upper frame 1 and the lower frame 3 are electrically connected with each other and the upper frame 1 is assumed to have the reference potential (GND).

Further, a hole 12 is formed in the mounting portion 10 of the lower frame 3, while a hole 13 is formed in the projecting portion 16 of the upper frame 1. These holes (12, 13) are used at the time of mounting the liquid crystal display module of this embodiment to a casing of a monitor or the like. For example, it is possible to mount the liquid crystal display module of this embodiment on the casing of the monitor or the like by inserting mounting screws in these holes (12, 13) and fastening the mounting portion 10 and the projecting portion 16 using these screws.

Here, in FIG. 2, numeral 7 indicates a mold of the direct backlight (BL), numeral 20 indicates a socket which is inserted into a terminal of an inverter printed circuit board (not shown in the drawing) which drives the cold cathode fluorescent lamp, and numerals 21, 22 indicate cables which supply electricity to the cold cathode fluorescent lamp.

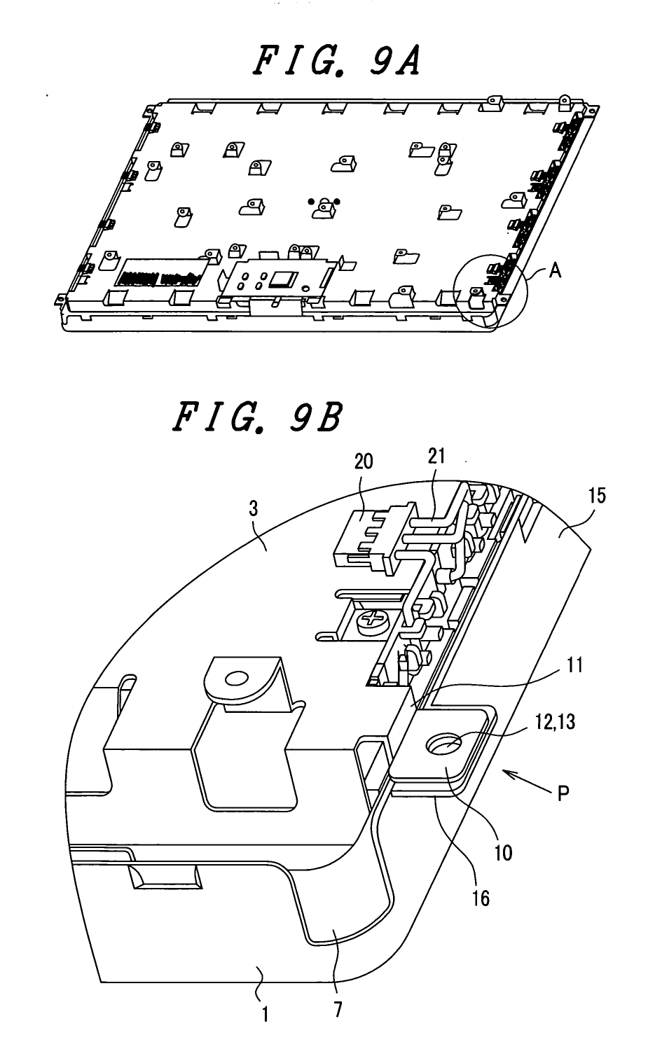

FIG. 9-a is a view showing a back surface side of a conventional liquid crystal display module (side opposite to a display screen of the liquid crystal display panel) and FIG. 9-b is a view showing a portion A in FIG. 9-a in an enlarged manner.

As shown in FIG. 9, in the conventional liquid crystal display module, to avoid a cable 21 of a backlight (BL), only one connecting portion 11 is provided for connecting a body portion of a lower frame 3 and a mounting portion 10 of the lower frame 3.

Accordingly, it is difficult to largely increase the strength of the connecting portion 11 and hence, when an impact of a given strength or more is applied in the direction indicated by an arrow P shown in FIG. 9, there exists a possibility that the connecting portion 11 is deformed.

However, according to this embodiment, as shown in FIG. 2, the body portion of the lower frame 3 and the mounting portion 10 of the lower frame 3 are connected to each other using two connecting portions 11 and, at the same time, a cable 21 of the backlight (BL) is pulled out through a space defined between these two connecting portions 11.

Due to such a constitution, according to this embodiment, it is possible to increase a lateral width (a length in the direction indicated by an arrow N in FIG. 2) of the connecting portions 11 compared to a lateral width of the conventional connecting portion and hence, the strength of the connecting portions 11 can be enhanced.

Accordingly, in a state that the liquid crystal display module of this embodiment is mounted on a monitor or the like, it is possible to enhance the vibration resistance and the impact resistance of the liquid crystal display module.

[Embodiment 2]

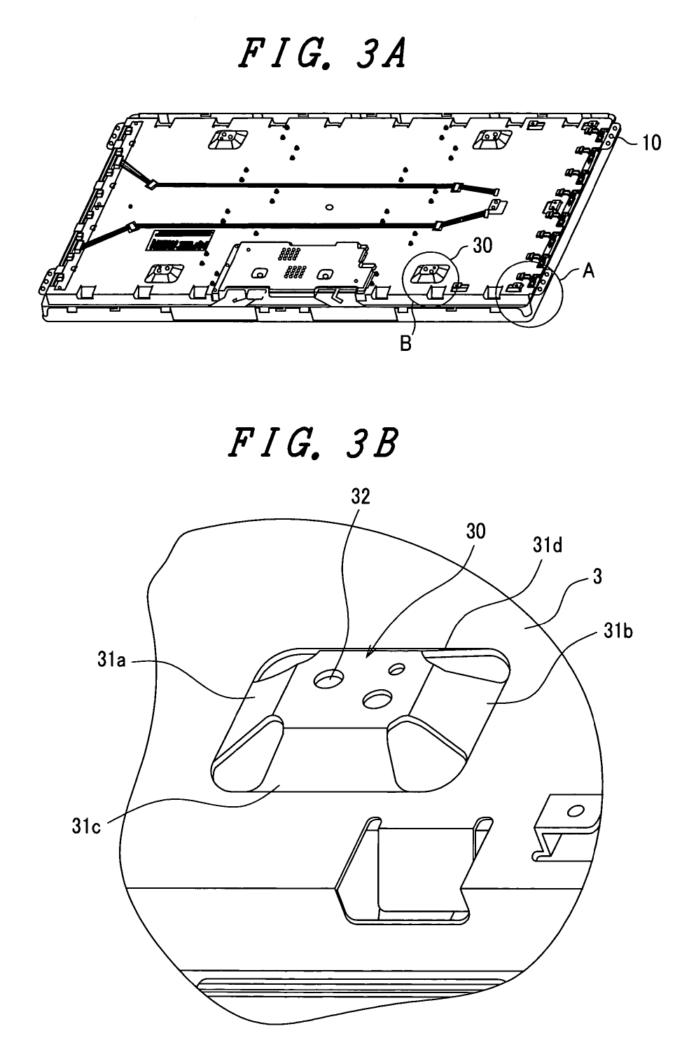

FIG. 3-a is a view showing a back surface side of a liquid crystal display module (side opposite to a display screen of the liquid crystal display panel) of an embodiment 2 of the present invention and FIG. 3-b is a view showing a portion B in FIG. 3-a in an enlarged manner.

In this embodiment, on a body portion of a lower frame 3, rear-mount mounting portions (second mounting portions) 30 having a quadrangular shape are formed and these rear-mount mounting portions 30 and the body portion of the lower frame 3 are connected with each other using four connecting portions (31a, 31b, 31c, 31d). Here, in this embodiment 2, although the rear-mount mounting portion 30 and the body portion of the lower frame 3 are connected with each other using four connecting portions (31a, 31b, 31c, 31d), the number of connecting portions is not limited to four. That is, three connecting portions or five connecting portions may be used, provided that the number of the connecting portions is three or more.

In the rear-mount mounting portion 30, a threaded hole 32 in which the mounting screw is threadedly engaged is formed.

In mounting the liquid crystal display module on a casing of a monitor or the like, in place of adopting the method which uses the mounting portions 10 explained in conjunction with the above-mentioned embodiment 1, there may be a case in which the rear-mount mounting portions 30 are used as in the case of this embodiment.

Accordingly, in this embodiment, to allow both mounting methods, the mounting portions 10 explained in conjunction with the above-mentioned embodiment 1 and the rear-mount mounting portions 30 are formed. Here, in FIG. 3, although the mounting portion 10 explained in conjunction with embodiment 1 corresponds to the portion indicated by A in FIG. 3-a, since this portion is identical with the corresponding portion in the previously-mentioned embodiments, the repeated explanation is omitted.

In the liquid crystal display module having the conventional rear-mount mounting portions 30, at two connecting portions (for example, connecting portions 31a, 31b in FIG. 3, for example), the body portion of the lower frame 3 and the rear-mount mounting portions 30 are connected with each other.

Accordingly, in the conventional liquid crystal display module having the rear-mount mounting portions 30, it is difficult to largely increase the strength of the connecting portions.

However, in this embodiment, as shown in FIG. 3, four sides of the rear-mount mounting portions 30 having a quadrangular shape and the body portion of the lower frame 3 are connected with each other using four connecting portions (31a, 31b, 31c, 31d).

Due to such a constitution, in this embodiment, the strength of the connecting portions 11 can be enhanced and hence, in a state that the liquid crystal display module of this embodiment is mounted on the monitor or the like, it is possible to enhance the vibration resistance and the impact resistance of the liquid crystal display module.

[Embodiment 3]

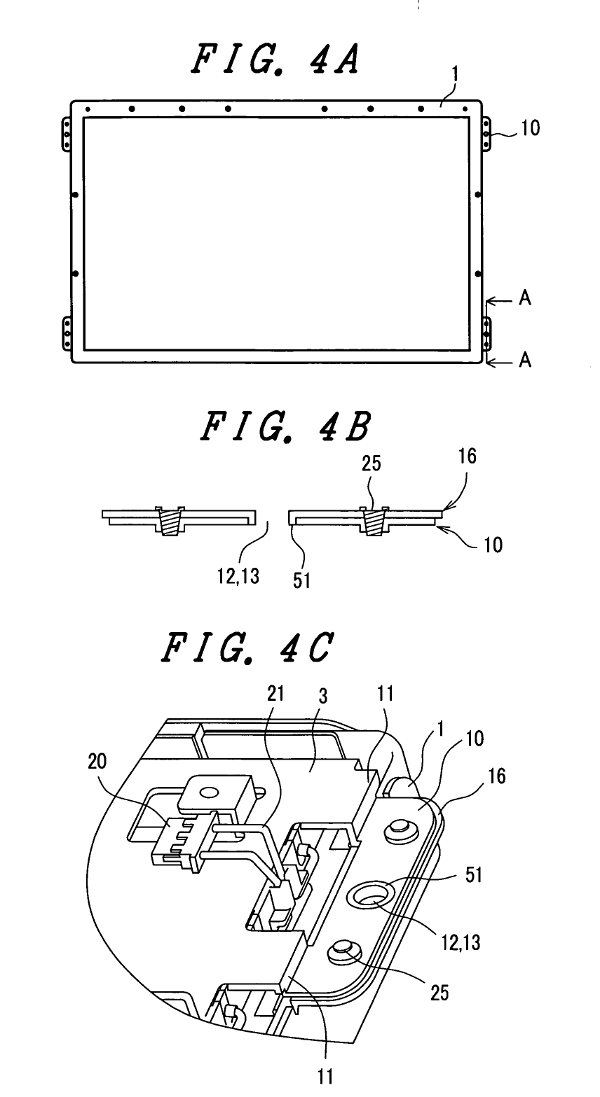

FIG. 4-a is a view showing a front surface side of a liquid crystal display module (a display screen side of the liquid crystal display panel) of an embodiment 3 of the present invention, FIG. 4-b is a cross-sectional view taken along a line A-A in FIG. 4-a and FIG. 4-c is a view of a portion B in FIG. 4-a as viewed from a back surface side (side opposite to the display screen of the liquid crystal display panel).

In this embodiment, a raised portion 51 is formed around a hole 13 formed in a projecting portion 16 of an upper frame 1, and the raised portion 51 is inserted into a hole 12 formed in a mounting portion 10 of a lower frame 3.

Due to such a constitution, according to this embodiment, it is possible to easily perform the positioning of the upper frame 1 and the lower frame 3.

As shown in FIG. 9, in the conventional liquid crystal display module having the direct backlight, no particular structure is adopted for positioning the upper frame formed on the front surface side of the liquid crystal display panel (the display screen side of the liquid crystal display panel) and the lower frame. Accordingly, in assembling the liquid crystal display module, there exists a possibility that between the upper frame and the lower frame (that is, the backlight (BL) and the liquid crystal display panel 2), the displacement of the assembled position such as the rotation occurs.

However, in this embodiment, the hole 13 and the raised portion 51 which is formed around the hole 13 are provided to the projecting portion 16 of the upper frame 1, and the raised portion 51 is inserted into the hole 12 which is formed in the mounting portion 10 of the lower frame 3 thus enabling the positioning of the upper frame 1 and the lower frame 3.

In general, the liquid crystal display panel 2 is positioned to the backlight (BL) mounted on the lower frame 3.

Accordingly, by positioning the upper frame 1 and the lower frame 3 in this embodiment, it is possible to reduce the irregularities including the rotation of the liquid crystal display panel 2 with respect to the upper frame 1.

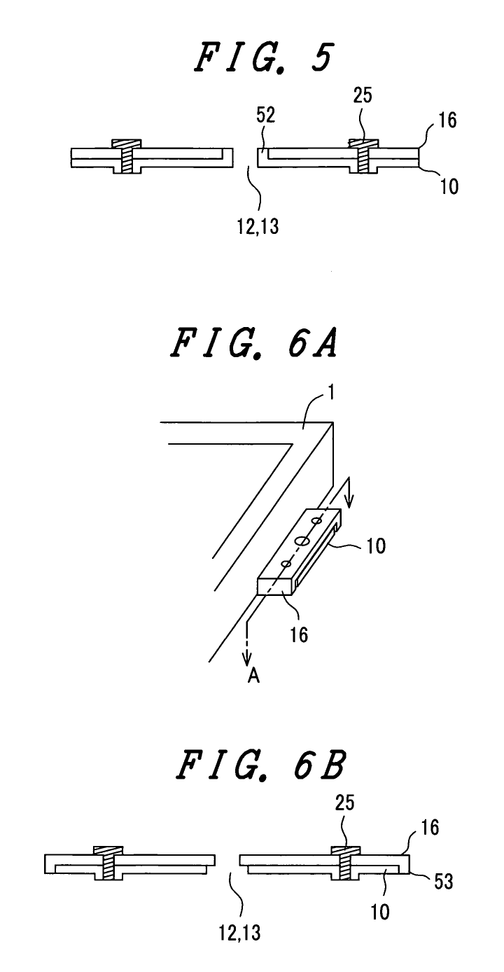

FIG. 5 is a cross-sectional view showing a modification 1 of this embodiment. That is, FIG. 5 is a cross-sectional view of the same portion as FIG. 4-b.

The modification shown in FIG. 5 is that a raised portion 52 is formed around a hole 12 formed in the mounting portion 10 of the lower frame 3 and the raised portion 52 is inserted into a hole 13 formed in a projecting portion 16 of the upper frame 1 thus positioning the upper frame 1 and the lower frame 3.

FIG. 6-a is a schematic view of a projecting portion 16 of the upper frame 1 as viewed from the front surface side (display screen side of the liquid crystal display panel) in a modification of this embodiment and FIG. 6-b is a cross-sectional view taken along a line A-A in FIG. 6-a.

In the modification shown in FIG. 6, a raised portion 53 is formed on the projecting portion 16 of the upper frame 1 and the mounting portion 10 of the lower frame 3 and the projecting portion 16 of the upper frame 1 are positioned using this raised portion 53 whereby the upper frame 1 and the lower frame 3 are positioned.

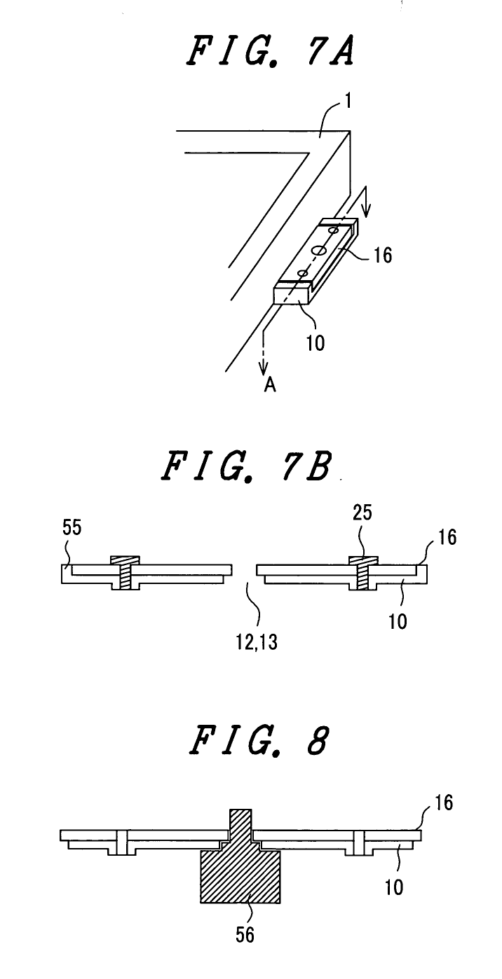

Here, in FIG. 7, although the raised portion 53 is formed in a portion of the periphery of the projecting portion 16 of the upper frame 1 in FIG. 6, the raised portion 53 may be formed on the whole periphery of the projecting portion 16 of the upper frame 1.

FIG. 7-a is a schematic view of a projecting portion 16 of the upper frame 1 as viewed from the front surface side (display screen side of the liquid crystal display panel) in a modification of this embodiment and FIG. 7-b is a cross-sectional view taken along a line A-A in FIG. 7-a.

In the modification shown in FIG. 7, a raised portion 55 is formed on the mounting portion 10 of the lower frame 3 and the mounting portion 10 of the lower frame 3 and the projecting portion 16 of the upper frame 1 are positioned using the raised portion 55 whereby the upper frame 1 and the lower frame 3 can be positioned.

Here, in FIG. 7, the raised portion 55 is formed on a portion of the periphery of the mounting portion 10 of the lower frame 3, the raised portion 55 may be formed on the whole periphery of the mounting portion 10 of the lower frame 3.

FIG. 8 is a cross-sectional view showing a modification of this embodiment.

In this embodiment, a jig 56 is used. First of all, the jig 56 is inserted into the hole 12 formed in the mounting portion 10 of the lower frame 3 and, thereafter, the jig 56 is inserted into the hole 13 formed in the projecting portion 16 of the upper frame 1 and, thereafter, the liquid crystal display module is assembled.

The jig 56 includes a portion which has a diameter equal to a diameter of the hole 12 formed in the mounting portion 10 of the lower frame 3 and a portion which has a diameter equal to a diameter of the hole 13 formed in the projecting portion 16 of the upper frame 1 and hence, it is possible to perform the positioning of the upper frame 1 and the lower frame 3 also using this method.

Here, although the explanation has been made with respect to the embodiments in which the present invention is applied to the liquid crystal display device in the above-mentioned respective embodiments, the present invention is not limited to these embodiments. That is, it is needless to say that the present invention is also applicable to display devices which use an EL display panel having organic EL elements or inorganic EL elements.

Although the inventions made by inventors of the present inventions have been specifically explained in conjunction with the above-mentioned respective embodiments, it is needless to say that the present invention is not limited to these embodiments and various modifications can be made without departing from the gist of the present invention.

1. A display device comprising:
a display panel; and
a lower frame which is arranged on a side opposite to a display screen of the display panel, wherein
the lower frame includes:
a body portion which is positioned on a back surface side of the display screen of the display panel;
a mounting portion which projects toward the outside of the display panel; and
a plurality of connecting portions which connect the body portion and the mounting portion.

2. A display device according to claim 1, wherein the plurality of connection portions are folded toward the mounting portion from the body portion.

3. A display device according to claim 1, wherein a cable for electric parts which is arranged between the display panel and the lower frame is pulled out from a space defined between the plurality of connecting portions.

4. A display device according to claim 1, wherein a plurality of light sources are arranged between the display panel and the lower frame, and a cable for some light sources out of the plurality of light sources is pulled out from a space defined between the plurality of connecting portions.

5. A display device comprising:
a display panel; and
a lower frame which is arranged on a side opposite to a display screen of the display panel, wherein
the lower frame includes:
a body portion which is positioned on a back surface side of the display screen of the display panel;
a mounting portion which projects toward a side opposite to the display screen of the display panel from the body portion, and
three or more connecting portions which connect the body portion and the mounting portion.

6. A display device according to claim 5, wherein the mounting portion has a quadrangular shape, and the plurality of connecting portions connect four sides of the mounting portion and the body portion.

7. A display device comprising: a display panel; an upper frame which is arranged at a display screen side of the display panel; and a lower frame which is arranged on a side opposite to a display screen of the display panel, wherein
the lower frame includes a mounting portion which projects toward the outside of the display panel,
the upper frame includes a projecting portion which projects toward the outside of the display panel and is fixed to the mounting portion of the lower frame,
the projecting portion of the upper frame includes a first mounting hole,
the mounting portion of the lower frame has a second mounting hole and a raised portion which is formed around the second mounting hole, and
the raised portion which is formed around the second mounting hole is inserted into the first mounting hole.

8. A display device according to claim 7, wherein the upper frame includes a side wall, the projecting portion of the upper frame is formed on the side wall, and the lower frame includes a body portion which is positioned on a back surface side of the display panel and a connecting portion which is folded toward the mounting portion from the body portion.

9. A display device comprising:
a display panel; an upper frame which is arranged at a display screen side of the display panel; and
a lower frame which is arranged on a side opposite to a display screen of the display panel, wherein
the lower frame includes a mounting portion which projects toward the outside of the display panel,
the upper frame includes a projecting portion which projects toward the outside of the display panel and is fixed to the mounting portion of the lower frame,
the projecting portion of the upper frame includes a first mounting hole and a raised portion which is formed around the first mounting hole,
the mounting portion of the lower frame includes a second mounting hole, and
the raised portion which is formed around the first mounting hole is inserted into the second mounting hole.

10. A display device according to claim 9, wherein the upper frame includes a side wall, the projecting portion of the upper frame is formed on the sidewall, and the lower frame includes a body portion which is positioned on a back surface side of the display panel and a connecting portion which is folded toward the mounting portion from the body portion.

11. A display device comprising: a display panel; an upper frame which is arranged at a display screen side of the display panel; and a lower frame which is arranged on a side opposite to a display screen of the display panel, wherein
the lower frame includes a mounting portion which projects toward the outside of the display panel,
the upper frame includes a projecting portion which projects toward the outside of the display panel and is fixed to the mounting portion of the lower frame, and
the projecting portion of the upper frame has a raised portion for positioning the mounting portion of the lower frame and the projecting portion of the upper frame.

12. A display device according to claim 11, wherein the upper frame includes a side wall, the projecting portion of the upper frame is formed on the side wall, and the lower frame includes a body portion which is positioned on a back surface side of the display panel and a connecting portion which is folded toward the mounting portion from the body portion.

13. A display device comprising:
a display panel;
an upper frame which is arranged at a display screen side of the display panel; and
a lower frame which is arranged on a side opposite to a display screen of the display panel, wherein
the lower frame includes a mounting portion which projects toward the outside of the display panel,
the upper frame includes a projecting portion which projects toward the outside of the display panel and is fixed to the mounting portion of the lower frame, and
the mounting portion of the lower frame has a raised portion for positioning the mounting portion of the lower frame and the projecting portion of the upper frame.

14. A display device according to claim 13, wherein the upper frame includes a side wall, the projecting portion of the upper frame is formed on the side wall, and the lower frame includes a body portion which is positioned on a back surface side of the display panel and a connecting portion which is folded toward the mounting portion from the body portion.
